(19) United States
(12) Patent Application Publication
(10) Pub. No.: US 2011/0266870 A1
(43) Pub. Date: Nov. 3, 2011

(54) MASTER/SLAVE POWER STRIP WITH DELAY MECHANISM

(76) Inventor: Huan Yu Hu, Chino Hills, CA (US)

(21) Appl. No.: 13/100,086

(22) Filed: May 3, 2011

Related U.S. Application Data
(63) Continuation-in-part of application No. 12/608,778, filed on Oct. 29, 2009, now abandoned.

(51) Int. Cl. H02J 3/14

(52) U.S. Cl. 307/39

(57) ABSTRACT

The present invention is directed toward a power distribution apparatus being connected to a power source. The invention having a control, or master, power outlet to be connected to a control device, at least one automatically switched, or slave, power outlet to be connected to at least one automatically switched device, a computing component for determining when a power level associated with the control device fall below or rises above a threshold in response to the control device being turned on and off, and for interrupting a power supply on a time delay basis to the at least one automatically switched power outlet when the computing component determines the power levels associated with the control device fall below or rises above the threshold.

### REFERENCE TO PENDING APPLICATIONS

This application is based on U.S. patent application Ser. No. 12/608,778 entitled MASTER/SLAVE POWER STRIP WITH DELAY MECHANISM filed Oct. 29, 2009.

### BACKGROUND OF THE INVENTION

The present invention is generally directed toward a master/slave-type power strip more specifically, toward a master/slave-type of power strip having the capability to delay the shutoff of power to linked devices.

As used herein, the term power strip refers to a device that provides electrical power to multiple pieces of linked electronic equipment. Further, these devices can include surge protection and electric filtering capabilities.

When a “master” device, such as a television or computer, which is plugged into a “master” outlet is turned on, power is then supplied to slave outlets such that the linked or “slave” devices, for example, printers, stereo receivers, DVD players, speakers, home theater systems, game consoles, etc which are plugged into the “slave” outlets now also receive power. When the “master” device is turned off, the “slave” devices are cut off from the power source. One concern is that when the power to the “master” device is turned off, the power to the “slave” devices is simultaneously and immediately turned off, which can cause damage to some of the linked devices. Moreover the linked plugs may power a light which would also be immediately turned off creating a dangerous condition. There is a need for a master/slave power strip having the ability to delay the powering off of the linked or “slave” devices.

### BRIEF SUMMARY OF THE INVENTION

The present invention satisfies the needs discussed above. The present invention is generally directed toward a master/slave-type power strip, more specifically, toward a master/slave-type of power strip having a delay mechanism which avoids the disadvantages of the prior art.

One aspect of the present invention discloses a power strip having a master power plug and a plurality of slave plugs. The master plug is used to power a piece of electronic equipment, such as a television or computer, which is referred to as the “master device”. The slave plugs are linked to the master plug and are typically used by additional pieces of electronic equipment, such as DVD players, speakers, gaming equipment and home theater systems. When the “master device” is turned off, the present invention detects the drop in the power current used by the master device and then begins a process to shut off the power provided to the slave plugs after a delay in time, which delay can be set at any length, such as 30, 60, 90 or more seconds.

An embodiment of the invention discloses a power strip receiving power from an external source. This power is then subjected to filtering and temperature controls, and then provided to the “master” outlet and various “slave” outlets. A microprocessor monitors the power levels of the device in the “master” outlet. In this embodiment, the microprocessor measures the wattage being used by the various devices connected to the power strip. The power levels are then digitally calculated by the microprocessor based on the wattage values.

When computer component, such as a microprocessor determines that a drop in the wattage associated with the “master” outlet has occurred, the microprocessor is enacted, which then cycles for a period of time then cutoffs power to the “slave” outlets. The amount of time for the microprocessor to cycle prior to the power cutoff can be pre-established or can be user-established. In addition the master/slave power strip will incorporate a network connection such that the power strip can be monitored and controlled via wired or wireless internet connections. Each power outlet will have the ability to receive signals for powering on or off by commands from the internet.

One embodiment of the microprocessor discloses the ability to receive signals from one or more external sources, compute the wattage being used by the “master” outlet and then issue a cutoff command to the “slave” outlets if the wattage is below a certain level. Additionally, the microprocessor can have the ability to provide the power usage read out to a LCM or LCD module for power usage monitoring.

Upon reading the above description, various alternative embodiments will become obvious to those skilled in the art. These embodiments are to be considered within the scope and spirit of the subject invention, which is only to be limited by the claims which follow and their equivalents.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

### BRIEF DESCRIPTION OF THE DRAWINGS

FIG. 1 is a view showing an apparatus in accordance with the first embodiment of the invention;

FIG. 2 is a block diagram in accordance with the first embodiment of the present invention as shown in FIG. 1.

FIG. 3 is a view showing an apparatus in accordance with the second embodiment of the invention.

FIG. 4 is a view showing an apparatus in accordance with the third embodiment of the invention.

FIG. 5 is a view showing an apparatus in accordance with the fourth embodiment of the invention.

FIG. 6 is a schematic view of a fourth embodiment of the present invention.

FIG. 7 is a block view of the fourth embodiment as shown in FIG. 6.

### DETAILED DESCRIPTION OF THE INVENTION

The attached drawing demonstrates an embodiment of the present invention. It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

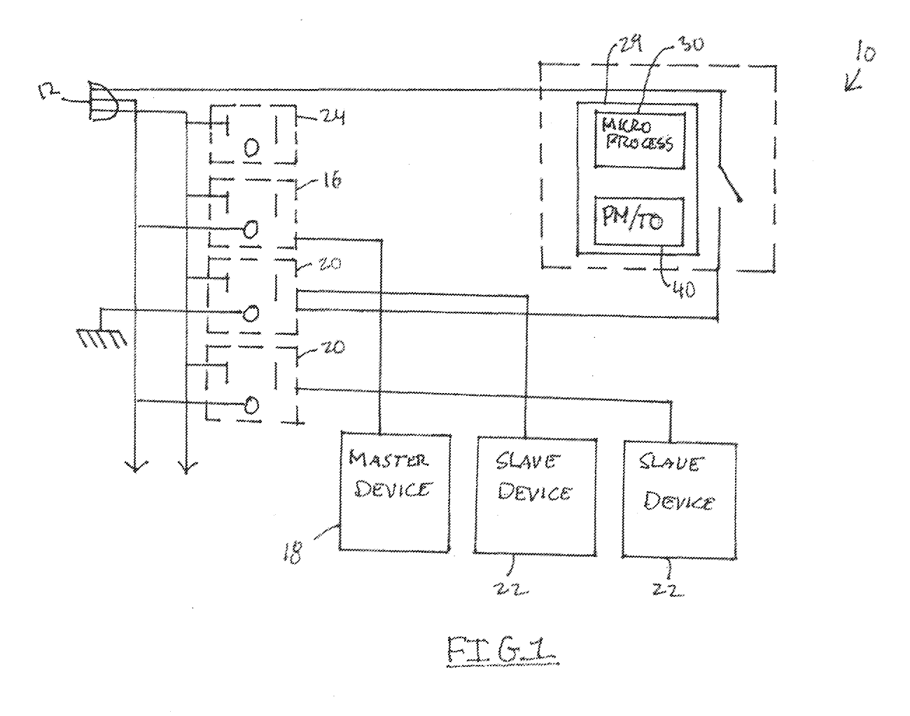

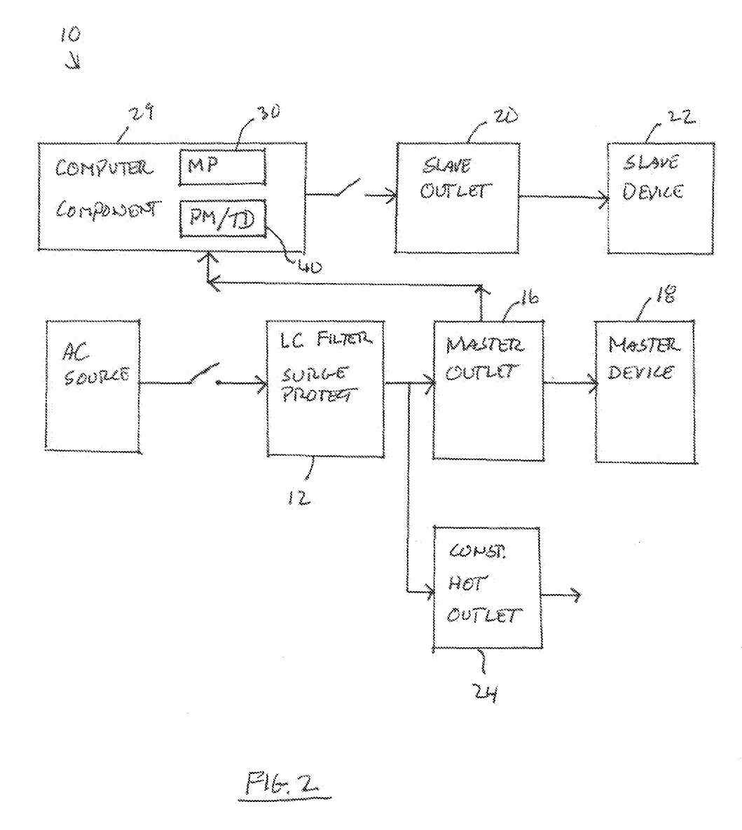

As shown in FIGS. 1 and 2, an embodiment 10 of the present inventive apparatus for power distribution to devices comprises a power inlet 12 provided with a surge protection 14 and a circuit breaker 16 which is connectable to an AC power source. A master power outlet 16 is provided for connecting to a master device 18, such as a computer or television. At least one, and preferably a plurality of slave power outlets 20 are provided for connection to slave devices 22, such as a gaming console, DVD player and other home theater associated accessories. A constant hot outlet 24, sometimes referred to as a “regular outlet”, is an outlet that can never be turned off even the master power is off and does not affect or is not affected by the power provided to other devices.

Embodiment 10 further has a computer component 29 which can learn various settings and data associated with various master device 18 and slave devices 22. In this embodiment, computing component 29 includes microprocessor 30 that is used for determining when a wattage level associated with the power across the master power outlet 16 falls below or rises above a threshold in response to the master device 18 being turned on and off. The computer component 29 can include a power modulating/timing delay component 40 for interrupting a power supply on a time delay basis to slave power outlets 20 when microprocessor 30 digitally calculates that the wattage levels of master power outlet 16 has fallen below a threshold value. Microprocessor 30 calculates the wattage levels by a series of computations. One such computation is based on the amount of current and voltage that flows across the control power outlet 16.

In operation, when control device 18 is powered down, microprocessor 30 will determine when the wattage to master device 18 drops below a threshold and then power modulating/timing delay component 40 will begin the countdown of the preset timer to interrupt power to slave devices 22 after a predetermined time delay period.

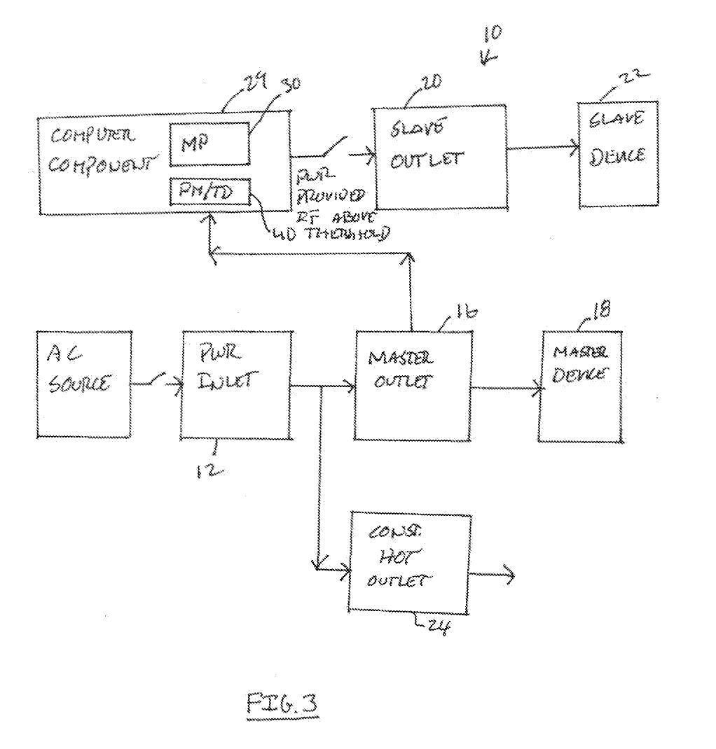

The embodiment of the present invention as shown in FIG. 3 substantially corresponds to the apparatus shown in FIG. 1. However, the power modulating/timing delay component 40 is further able to supply power on a time delay basis to at least one slave power outlet 20 when the microprocessor 30 determines the wattage levels above the threshold. This allows for the providing of power over a time delayed basis to slave devices 22 when power is no longer provided to master device 18 via master power outlet 16.

In the embodiment, microprocessor 30 is configured to avoid a potential misread on whether power has truly been turned on for any master device 18 that is connected to master power outlet 16. Microprocessor 30 can provide either a very short time delay prior to determining whether to provide power to slave” outlets or can use a “error correction” mechanism. This will allow the microprocessor 30 to have the ability to determine whether the sudden surge of power usage is caused by the powering-on of the master device 18 connected to master power outlet 16 or whether the power surge detected was an inrush of current created when master device 18 was first plugged into master power outlet 16 even without turning on master device 18. Such inrush of current can occur when power rushes into master device 18 to fill the master device's 18 capacitors.

The microprocessor 30 is also provided to be able to determine the wattage levels representative of master devices 18 that are consistent with a power-on setting and a power-off setting for that master device 18. Further, power modulating/timing delay component 40 is provided to be able to determine wattage levels representative of the slave devices 22 that are consistent with a power-on setting and a power-off setting for each of the slave devices 22. For example, microprocessor 30 calculates the power usage of a laptop computer connected to the “master” outlet while the device is in standby mode to be 10V. This value is then set as its threshold value. In the event the laptop's battery is not at full capacity, the wattage value increases which calculates to a higher power usage, such as 30V. The threshold value for power cutoff, however, will not be altered, but will remain as the lower 10V.

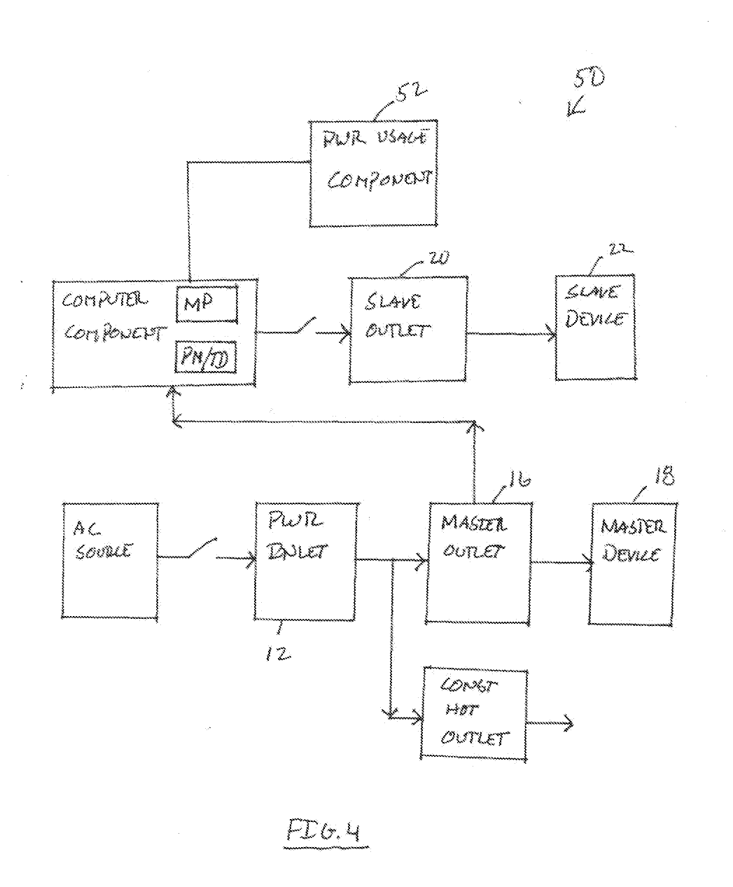

In the embodiment 50 of the present invention as illustrated in FIG. 4, the apparatus further comprises power usage component 52 for displaying the total power usage of the apparatus. Power usage component 52 can include various visual displays such as a power usage meter.

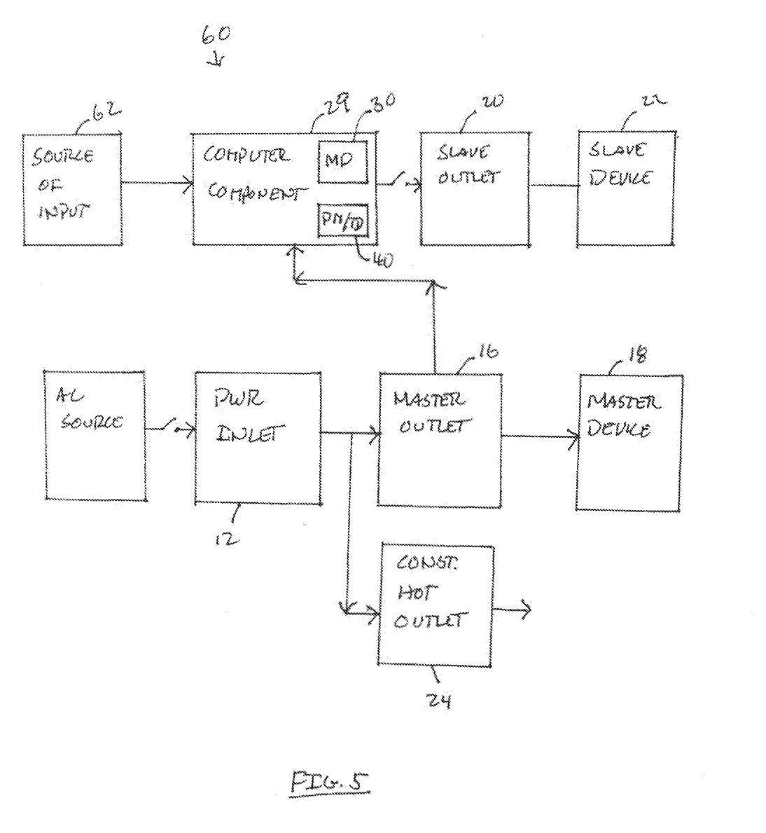

In the embodiment 60 of the present invention as illustrated in FIG. 5, the microprocessor 30 has the ability to have the capability to network with other sources of input 62 in order to determine whether to begin a power-down or power-up cycle. These other sources of input 62 can include a computer network, a building security system or any other form of input wherein a time delayed power-down or power-up cycle would be advantageous. For example, embodiment 60 can be in communication with a building's security system that utilizes a smart card access protocol via a wire or wireless connection. When a person leaves the building, that person's smart card is engaged. Microprocessor 30 senses when the user's smart card has been engage and begins a power-down cycle. Likewise, microprocessor 30 senses when a person enters a building and utilizes a smart card for access therein and then begins a power-up cycle for the devices associated with this embodiment 60 of the inventive apparatus.

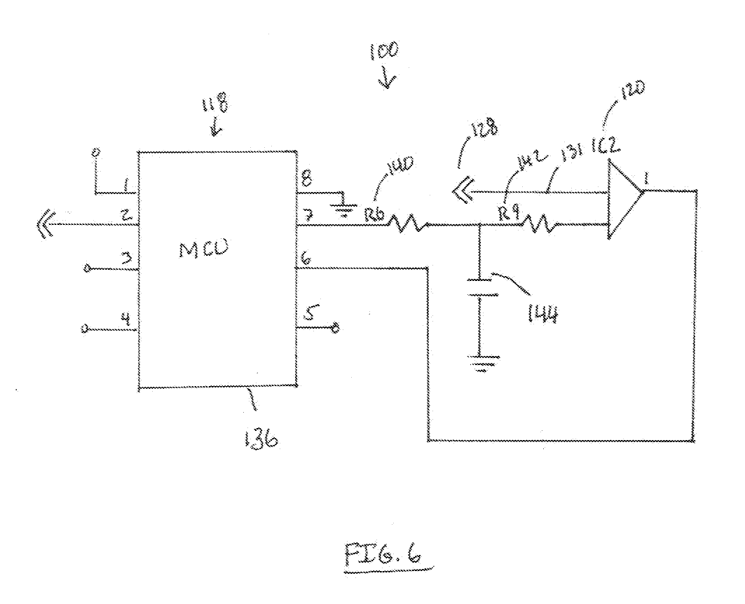

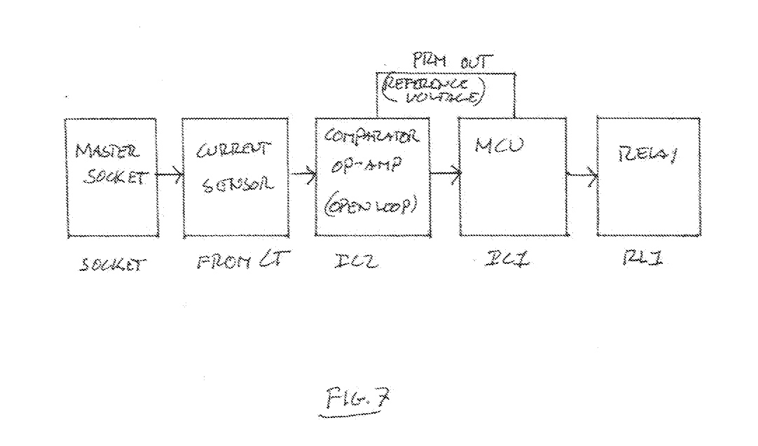

In Illustrated in FIGS. 6 and 7, an additional embodiment 100, is illustrated. Embodiment 100 is directed toward an apparatus for power distribution similar to those previously described having a master outlet and one or more slave outlets. Embodiment 100 includes a series of resistors, capacitors and diodes to provide DC power supply to a relay switch. A zener diode and a second series of capacitors produce the power supply for the microprocessor 118 and the comparator 120.

As shown in the Figures, the power for master outlet is supplied constantly along with the constant outlets, whereas the power for slave outlets is supplied depending on the status of the relay switch.

The sensing means 132 of the comparator 120 is comprised of a current transformer 128, which is connected (as shown in the figure) to measure the current flow through the master outlet and produce a power usage measurement signal. The power usage measurement signal is derived into a DC voltage value.

The comparator 120 is comprised by using a op-amp with an open loop circuitry. It compares the signal 131 from the sensing circuit 132, input 134, and the PWM signal 135 generated from a microprocessor 136. The comparator 120 sends a H (high) signal to the microprocess 136 when the value of PWM signal 135 is greater than signal 131 and a L (low) signal is delivered to microprocessor 136 when the value of PWM signal 135 is smaller than signal 131. In this arrangement, H signal means master outlet is using less power than the threshold level sent from comparator 120 and that microprocessor 136 needs to turn off power to the one or more slave outlets via relay switch. Likewise, a L signal sent from comparator 120 means microprocessor 136 needs to turn on power to the one or more slave outlets via relay switch.

More specifically, microprocessor 136 sends two different PWM (Pulse Width Modulation) signals 135, depends on the slave outlet's status, at a fixed frequency to comparator 120. The signal is then derived into a fixed DV voltage signal by the arrangement of R6 (140), R9 (142) and C5 (144) shown in the figure. The two different PWM signals 135 are pre-determined signals, S-on and S-off, and act as the High (on) and Low (off) threshold for the one or more slave outlets. S-on is sent to the comparator for comparison when relay switch is turned on and S-off is sent when relay switch is turned off.

Another embodiment 150 discloses the power distribution apparatus discloses above with the following additions. When microprocessor 136 receives a L signal (2>3) from comparator 120, a digital “Turn on Error Correction Process” is activated, this mechanism will require the microprocessor 136 to receive a pre-determined amount of feedback signals or until the signal is steady before delivering the command to turn on relay switch. This is to protect the device from false reading cause d by in-rush current. Once the error correction mechanism period is over, a turn on signal will be sent to K1 via the 2nd pin of microprocessor 136. The “turn on” signal is a fixed voltage signal that's higher than the “turn off” relay switch on the higher or lower voltage signal, the transistor will either supply or interrupt the power supply to relay switch.

When microprocessor 136 receives a H signal (2<3) from comparator 120, a software “Turn off Error Correction Plus Protection Process” will be activated, this mechanism will require microprocessor 136 to receive a pre-determined amount of feedback signals before turning relay switch off, however, during the countdown period, if a L signal is received from the comparator, the software will reset and goes back to the normal operation mode without turning off relay switch until a H signal is received again. Once the process period is over, a turn off signal will be sent to relay switch via microprocessor 136.

Additionally, once relay switch is turned on, a S-on signal is sent from comparator 120 to be compared with the power usage of the Master device. Once the master device is turned off, the signal generated from the comparator will be H, so the “Turn off Error Correction Plus Protection Process” is started for the turning off procedure. This process is designed to eliminate the false turn off of the master device and also to give the devices connected to the slave outlets to stop working mechanically before interrupting the power supply. Power interruption to electrical appliances with mechanical components can cause serious damage to the device.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. An apparatus for power distribution to devices, said apparatus comprising:
a power inlet to be connected to a power source;
a computing component, said computing component having a microprocessor, a current transformer and a comparator;
a master power outlet to be connected to a master device, said master device having a master device power level; and
at least one slave power outlet to be connected to at least one slave device,
wherein said microprocessor generating a first predetermined threshold signal to turn on power to said at least one slave power outlet and a second predetermined threshold signal to turn off power to said at least one slave power outlet,
wherein said microprocessor sends said first predetermined threshold signal to said comparator to compare with said master device power level and when said master device power level is greater than said first predetermined threshold signal said comparator will generate a “turn on” signal back to said microprocessor where said computing component provides power to said at least one slave power outlet, and
wherein said microprocessor sends said second predetermined threshold signal to said comparator to compare with said master device power level and when said master device power level is less then said second predetermined threshold signal said comparator will generate a “turn off” signal back to said microprocessor where said computing component interrupts power to said at least one slave power outlet.

2. An apparatus as defined in claim 1, wherein said computing component includes a power modulating/timing delay subcomponent, said power modulating/timing delay subcomponent interrupting a power supply on a time delay basis to said at least one slave power outlet when said comparator determines that said master device power level is less then said second predetermined threshold signal.

3. An apparatus as defined in claim 1, wherein said computing component determines said first master device voltage level utilizing said current transformer to calculate the voltage being used across said master power outlet.

4. An apparatus as defined in claim 1, wherein said power modulating/timing delay component further supplies a power supply on a time delayed basis to said at least one slave power outlet when said computing component determines said first master device voltage level is above said second master device voltage level.

5. In a master/slave power distribution apparatus having a plurality of slave devices linked to a master controlling device, wherein said improvement comprising a
computer component to determine a first power usage associated with the master power outlet when the master power device has been powered on creating a first master device voltage level and to determine a second power usage associated with the master power outlet when the master power device has been powered off creating a second master device voltage level; and
a time delay component for interrupting a power supply on a time delay basis to the slave devices when a computing component determines said first power usage level is less than said second power usage level.

6. An apparatus as defined in claim 5, wherein said computing component storing pre-established second power usage level values for said master controlling device.

7. An apparatus as defined in claim 5, wherein said computing component determines and stores said second power usage level values for said master controlling device.

8. An apparatus as defined in claim 5, wherein said computing component interrupts said power supply on a time delay basis to said master controlling device and said plurality of slave devices based on input from one or more external sources.

9. An apparatus as defined in claim 8, wherein said one or more external sources is defined as a computer network.
